(19) United States
(12) Patent Application Publication
(10) Pub. No.: US 2003/0173269 A1
(43) Pub. Date: Sep. 18, 2003

(54) Sorting data with long SORT fields

(76) Inventor: Heinz-Gerhard Breden, Oberhausen (DE)

Correspondence Address: BAZERMAN & DRANGEL, P.C., 60 EAST 42ND STREET, SUITE 820, NEW YORK, NY, 10165, US

(21) Appl. No.: 10/376,582

(22) Filed: Feb. 28, 2003

Related U.S. Application Data
(60) Provisional application No. 60/360,616, filed on Mar. 1, 2002.

(51) Int. Cl. B07B 1/00

(52) U.S. Cl. 209/584; 209/1

(57) ABSTRACT

The invention relates to a method for sorting a data set comprising long data records, in particular data records of variable length up to 32 k bytes. To allow to use common SORT methods, the steps of reading an input data set comprising long data records, splitting said long data records into data segments of equal length, assigning unique segment numbers to each of said data segments, sorting said data segments, assigning sorted segment numbers to each of said sorted data segments, sorting said data segments by segment number, replacing said long data records within said input data with said sorted segment numbers of the respective data segments, thus reducing the size of said data records, sorting said reduced data records by their sorted segment number, and restoring said long data records by replacing said sorted segments with the respective data segments are proposed.

### PRIORITY

This application claims priority of U.S. Provisional application No. 60/360,616 filed on Mar. 1, 2002.

### BACKGROUND OF THE INVENTION

1. Field of the Invention

The present invention relates to a method for sorting a data set comprising long data records, in particular data records of variable length up to 32 k bytes, said method comprising the steps of reading an input data set comprising long data records, and sorting said input data set. The present invention further relates to a device for sorting long data records, a computer program and a computer program product.

2. Prior Art

Sorting of data records is necessary in virtually every field of data processing. All currently available SORT utilities have the restriction that all SORT fields (these are the parts of a data record by which the records are sorted) must lie within the first 4092 bytes of a data record. As a consequence, no SORT field may have a length larger than 4092. Furthermore, each SORT field must usually have the same fixed position and length in each record. There are circumstances when it is desirable to use a field as a sort criterion that is of fixed position but of variable length. The deficiencies of prior art SORT methods is the limitation to a size of maximum 4092 bytes for the SORT fields and the requirement of equally sized SORT fields.

It is thus an object of the invention to improve current SORT methods and to allow a more flexible sorting of data records. In many applications, in particular within relational databases, such as IBM's DB2, data records that are larger than 4092 bytes are processed. It should be possible to sort these records with common SORT utilities. It requires a high technical effort of software and hardware to sort long data records with proprietary SORT methods. The requirement of memory increases and processing speed reduces. It is an object of the invention to overcome these drawbacks. Further objects and advantages will become apparent from a consideration of the ensuing description and drawings

### SUMMARY OF THE INVENTION

In accordance with the present invention, the aforesaid objects are achieved by splitting said long data records into data segments of equal length, assigning unique segment numbers to each of said data segments, sorting said data segments, assigning sorted segment numbers to each of said sorted data segments, sorting said data segments by segment number, replacing said long data records within said input data set with said sorted segment numbers of the respective data segments, thus reducing the size of said data records, sorting said reduced data records by their sorted segment number, and restoring said long data records by replacing said sorted segments with the respective data segments.

By providing a method with these steps, the present invention lessens the restriction of prior art methods by allowing the rightmost SORT field to have a variable length of preferably up to 32K. Providing more efficiently sorted data to applications for subsequent processing improves application performance, thus reducing hardware requirements. Additionally, reducing multiple occurrences of data reduces physical storage requirements.

In a method according to the present invention, data records may have a header of a fixed size, followed by a data field of variable length. The data field may also be called “text portion” of a data record. The header and the data field should not exceed 32 k bytes. The data fields of each record are split into equally sized data segments. Each segment preferably has the size of 4092 bytes. For each segment within all data segments of all records, a unique segment number is assigned. This number is preferably a 4 byte number. The data segments are sorted according to a sort criterion by a sorting method, which may be any known SORT method.

After sorting the data segments according to a sorting criterion, the sorted data segments are assigned a sorted segment number, again preferably a 4 byte number. The sorted segment number represents the position of a data segment within all data segments after sorting. The sorted data segments are again sorted by their segment number. The initial sequence of data segments is restored, but the sorted segment number is known.

The data segments within the input data are replaced by their corresponding sorted segment numbers. Each segment within the input data is now represented by its sorted segment number. The size of the data records is reduced, so that these data records may be sorted by a SORT method which is restricted to a maximum size of preferably 4092 for the sort fields.

The reduced data records are sorted by a SORT method, whereby their sorted segment numbers are used for sorting. After that, the sorted data records are reassembled into their original size by replacing the sorted segment numbers by the original data of each data segment. The resulting data records are sorted and may be further processed.

It is preferred that said input data set comprises long data records and short data records and that said long data records are separated from said short data records. Long data records are preferably larger than 4092 bytes and short data records are preferably smaller. The size of the long data records depends on the SORT method used and its restriction concerning the length of the sort fields.

To allow sorting of data sets with both short and long data records, it is preferred that said short data records are sorted, and that said sorted short data records are merged with said sorted long data records. After sorting the short data records separately from the long data records, they may be merged, resulting in a completely sorted set of data records.

To allow an easy reassembly of the data segments after sorting and rearranging, it is preferred that after replacing said long data records within said data set with said sorted segment numbers of the respective data segments, the sequential position of the long data record within the original input data set and the segment number of its first data segment are saved with the reduced long data record. The sequential position of the long data record is the position of the data record within the data set. The data set may be any input data, such as a file, a stream or any other.

It is preferred that said data segments of said long data records are padded to equal size by adding dummy bits to the respective data segments and also that said short data records are padded to equal size by adding dummy bits to said short data records. To equalize the size of all data segments, the ones which do not have the required size are filled up with dummy bits, which are preferably 0 (zero) bits.

It is further preferred that said long data records are split into data segments sized at least 2048 bytes and at most 4092 bytes. The length depends on the storage space being used.

A further aspect of the invention is a device equipped for carrying out an above described method with extracting means for extracting long data records out of input data set, segmenting means for segmenting long data records into data segments of equal size, sorting means for sorting said data segments, for sorting said data segments by segment numbers, and for sorting said data records by said sorted segment numbers, storage means for storing outputs of said sorting means, replacing means for replacing said data segments by sorted segments numbers, and vice versa, and reassembling means for reassembling said long data records from said sorted data segments.

Yet a further aspect of the invention is a computer program implementing a pre-described method for a computer as well as a computer program product comprising such a computer program or instructions for carrying out a method as described above.

These and other aspects of the invention will be apparent from and elucidated with reference to the figures. The figures show:

### BRIEF DESCRIPTION OF THE DRAWINGS

FIG. 1 steps of a method according to the invention,

FIG. 2 a preparation of intermediate data sets,

FIG. 3 a processing of short records,

FIG. 4 a processing of long records,

FIG. 5 a reassembling of long records,

FIG. 6 data structures.

### DETAILED DESCRIPTION OF THE INVENTION

The invention describes a sort program that uses input in the form of data records of variable length.

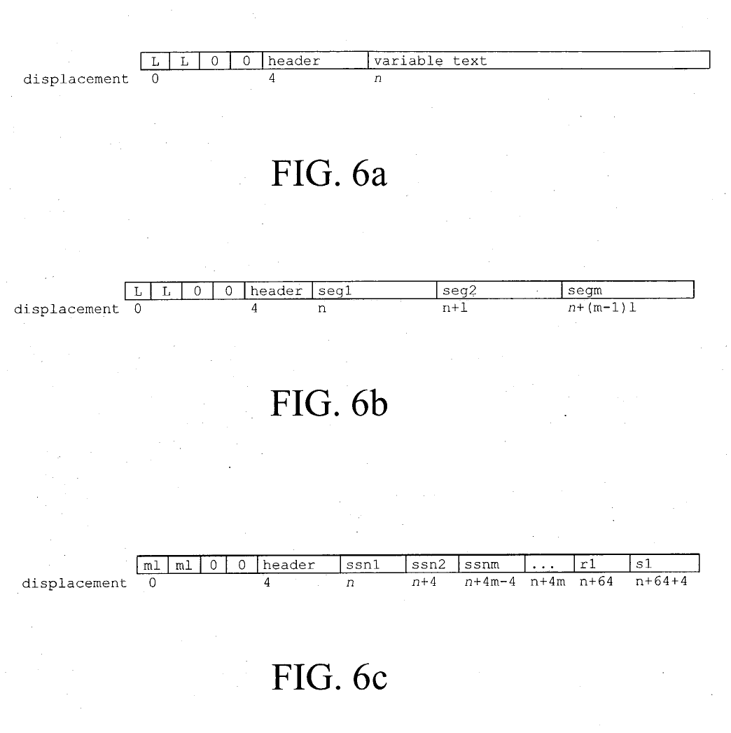

FIG. 6a depicts a data structure of a data record. Each record has a header of fixed length followed by a field of variable length, which is referred to as the “text portion” in the following description. The header length must be smaller than or equal to 4016, whereas the text length may be between 0 and 32K, such that the total record length does not exceed 32K. Each header may contain “normal” SORT fields (i.e., fields of fixed length at a fixed position). The text portion is used as an additional SORT criterion. In the following description, a record whose length does not exceed 4092 is called a “short record”, the other records are called “long records”. Short records can be sorted by any standard SORT utility, whereas long records need a special processing, as described below, before they can be transferred to the SORT utility. The process of sorting short and long records requires a varying number of steps depending on whether there are actually records of a length larger than 4092 bytes.

All data records have a standard variable format, as depicted in FIG. 6a, which means the first two bytes contain the record length (LL, not exceeding 32K), followed by two bytes with a value of zero. The text starts at position n, which is the same for all records. The value of n must not exceed 4016.

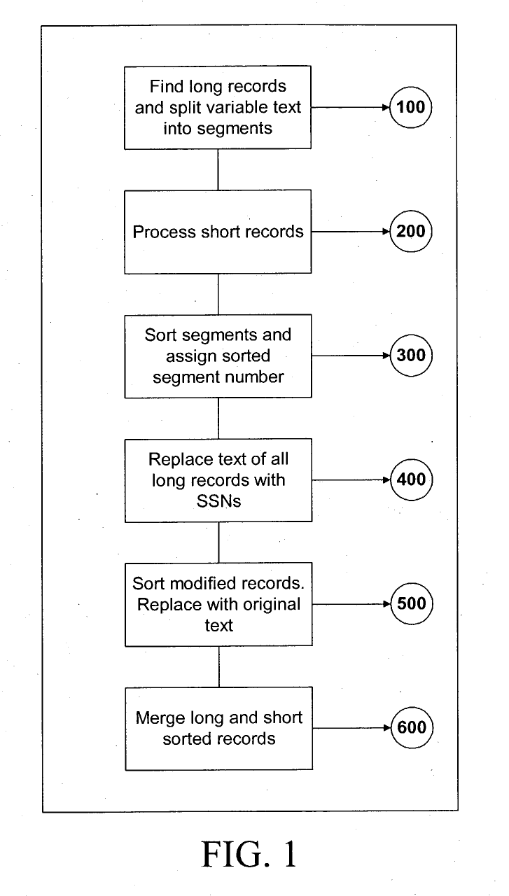

FIG. 1 depicts the steps of a method according to the invention. In a first step 100, long records are extracted and split into segments. In step 200, short records are sorted. In step 300, segments of long records are sorted and a segment number as well as a sorted segment number are assigned to the segments. In step 400, the segments are reduced in size. In step 500, the reduced segments are sorted and reassembled. Eventually in step 600 the sorted short and long data records are merged.

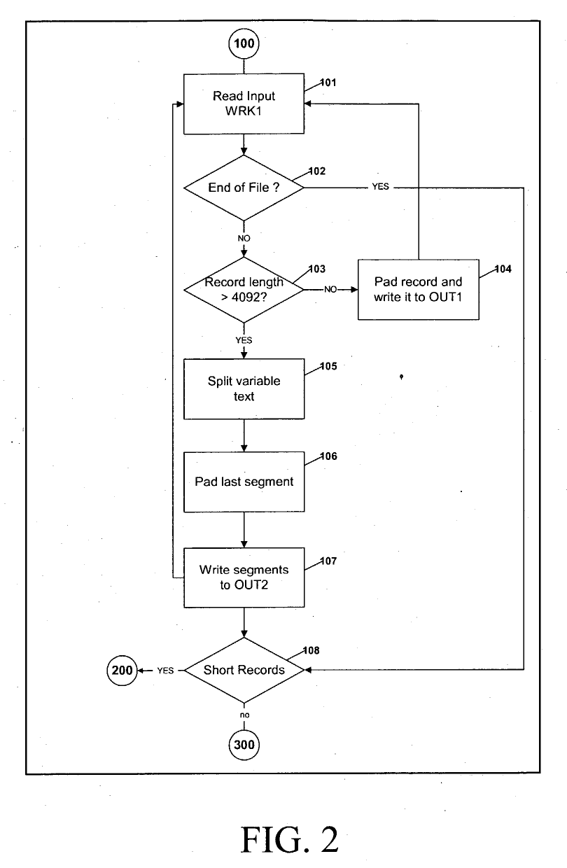

As can be seen from FIG. 2, the input data set WRK1 containing long and/or short data records is read by a standard input phase exit 101, which is a routine that receives control for each record being sorted before that record is transferred to the SORT utility. An end of file check is done 102. If not end of file, a check is made to identify long records based on whether or not the total length exceeds 4092 bytes 103. When a short record is found, whose length is less than or equal to 4092 bytes, it is padded with binary zeros as necessary up to 4092 bytes. The padding is performed to have a normal SORT field starting at fixed position n with fixed length 4092−n. The short record (possibly padded) is written to an output data set OUT1 104, which will eventually contain all short records.

When a long record is found 103, the text portion of the long record is split into one or more segments of equal length 105. The last segment is padded with binary zeroes if necessary 106. The data structure of a segmented long record can be seen from FIG. 6b.

The text is split into one or more segments of fixed length l (the last segment segm is padded if necessary). The length of a segment is at least 2048 bytes, and does not exceed 4092 bytes. The length further depends on the type of the SORTWORK space that is on the disk being used by the SORT utility, e.g., segment length depends on the track length in order to best utilize the available space. From the preceding explanation, m represents the number of segments, which will not exceed 32K/2048=16.

All segments are written to an output data set OUT2 107, which will eventually contain all segments for all long records. The sequence of segments in data set OUT2 is the same sequence in which these segments appear in the long records.

When the end of the input file is reached, any short records on the output data set OUT1 will be processed by step 200. Any long records will be further processed by step 300.

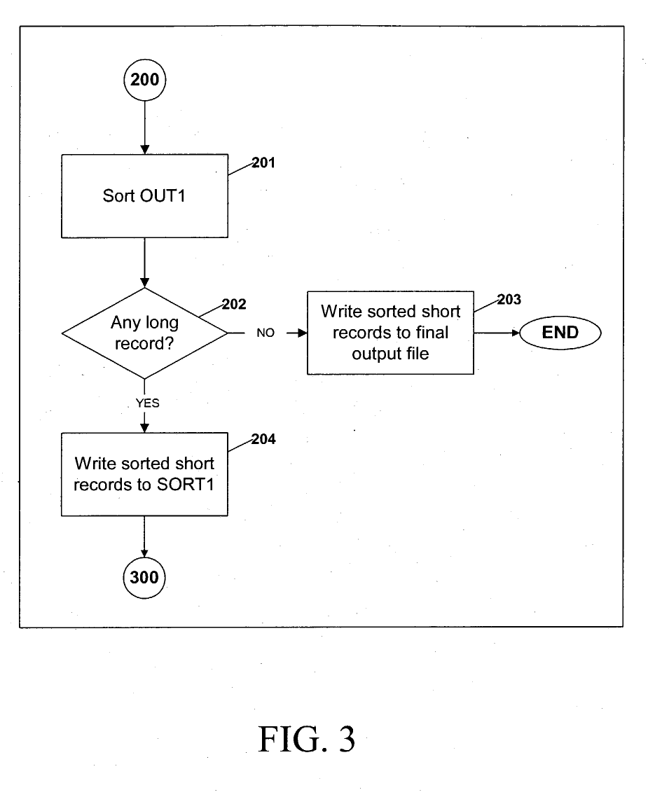

All short records on data set OUT1 are sorted using a standard SORT utility 201, as depicted in FIG. 3. During the output phase of the SORT utility, the padding bytes are removed, thus restoring the original short records. If there were no long records 202, all sorted short records are written to the final output data set 203 and processing ends. If there is at least one segmented long record on data set OUT2 202, then all sorted short records are written to an intermediate data set SORT1 204.

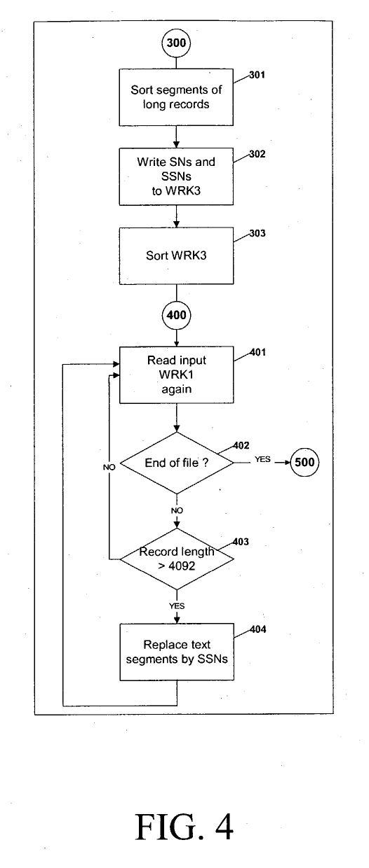

The processing of long records is depicted in FIG. 4. The segments of OUT2 are sorted, which is now possible because the segment length is at most 4092. Each segment of a long record is associated with a unique 4-byte number called the segment number (SN). This segment number denotes the position of the segment within the original input data set, and also the segment's position in OUT2. A standard output phase exit, which is a routine that receives control for each record leaving the SORT utility before the record is written to the final output data set, reads the sorted segments and inserts a 4-byte counter called the sorted segment number (SSN) 301. The sorted segment numbers correspond in a one-to-one relation to the SORT sequence of the associated segments: If segment A precedes segment B (according to the SORT criteria), then the relation SSN(A)<SSN(B) holds for their sorted segment numbers, and vice versa. For each text segment, a record containing the segment number and the sorted segment number is written to data set WRK3 302. Then, these records are sorted in respect to the segment number and written back to data set WRK3 303. From the preceding explanation, it is concluded that the n-th record in data set WRK3 contains the segment number of the n-th segment (which is n itself), and the sorted segment number of the n-th segment.

The original input data set WRK1 is read again 401, which is depicted in FIG. 4. The short records are ignored this time 403. For each long record, the text segments are replaced by their associated sorted segment numbers. Data set WRK3 is used to locate the sorted segment number of each segment 404. Additionally, the sequential position r1 of the data record within the original data set and the segment number s1 of its first segment are saved in the modified record.

FIG. 6c illustrates the long record after modification, where:

ssnx (ssn1, ssn2, etc.) denotes the sorted segment number of segment segx.

r1 denotes the sequential position of this record within the input data set WRK1.

s1 denotes the segment number of the record's first segment seg1, prior to being sorted.

3 dots (...) represent binary zeros. If the record has less than 16 segments (i.e., m<16), binary zeros are inserted after ssmn up to r1.

mlml denotes the length of the modified record.

Thus, the variable text portion is replaced by a character string of fixed length of 64 bytes (ssn1 through ssnm plus padding bytes), refer to 100. The associated 64-byte strings have the same sort sequence as the originating text portions. Since the sum n+64 does not exceed 4092, the modified long records can be processed by the SORT utility using the SORT fields in the header and the 64-byte string as SORT criteria.

When the end of file on the input data set is reached 402, processing continues 500.

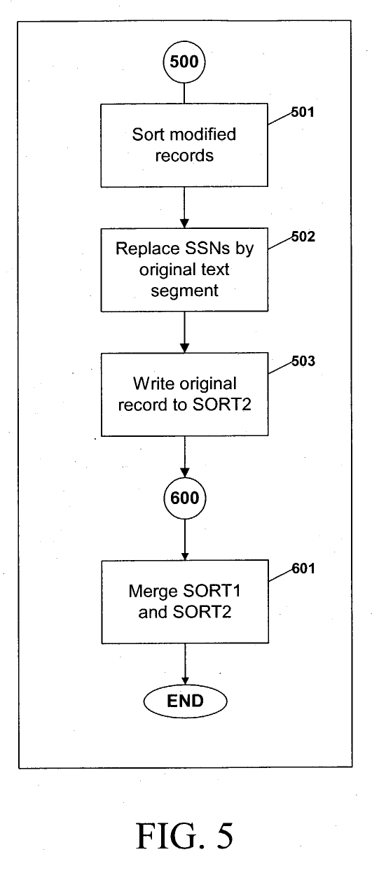

As depicted in FIG. 5, the modified long records are sorted 501. A standard output phase exit recreates the original long records. It uses the r1 and s1 values from a modified long record to locate the associated original text segments in data set OUT2. Then, the SSNs are replaced by these segments. Original records are written to data set SORT2.

The short records on data set SORT1 and the long records on data set SORT2 are merged 600 into a final output data set for data processing by subsequent applications.

By providing the method according to the invention, common SORT methods may be used to sort long data records. Thus memory requirements and processing time may be reduced.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than the examples given.

I claim:

1. A method for sorting a data set comprising long data records, in particular data records of variable length up to 32 k bytes, said method comprising the steps of:
reading an input data set comprising long data records,
splitting said long data records into data segments of equal length,
assigning unique segment numbers to each of said data segments,
sorting said data segments,
assigning sorted segment numbers to each of said sorted data segments,
sorting said data segments by said segment number,
replacing said long data records within said input data set with said sorted segment numbers of the respective data segments, thus reducing the size of said data records,
sorting said reduced data records by their sorted segment number, and
restoring said long data records by replacing said sorted segments with the respective data segments.

2. The method according to claim 1, wherein said input data set comprises long data records and short data records and wherein said long data records are separated from said short data records.

3. The method according to claim 1, wherein long data records having a size larger than 4092 bytes are sorted.

4. The method according to claim 2, wherein long data records having a size larger than 4092 bytes are sorted.

5. The method according to claim 2, wherein said short data records are sorted, and wherein said sorted short data records are merged with said sorted long data records.

6. The method according to claim 3-, wherein said short data records are sorted, and wherein said sorted short data records are merged with said sorted long data records.

7. The method according to claim 4, wherein said short data records are sorted, and wherein said sorted short data records are merged with said sorted long data records.

8. The method according to claim 1, wherein after replacing said long data records within said input data set with said sorted segment numbers of the respective data segments, the sequential position of the long data record within the original input data set and the segment number of its first data segment are saved with the reduced long data record.

9. The method according to claim 2, wherein after replacing said long data records within said input data set with said sorted segment numbers of the respective data segments, the sequential position of the long data record within the original input data set and the segment number of its first data segment are saved with the reduced long data record.

10. The method according to claim 3, wherein after replacing said long data records within said input data set with said sorted segment numbers of the respective data segments, the sequential position of the long data record within the original input data set and the segment number of its first data segment are saved with the reduced long data record.

11. The method according to claim 4, wherein after replacing said long data records within said input data set with said sorted segment numbers of the respective data segments, the sequential position of the long data record within the original input data set and the segment number of its first data segment are saved with the reduced long data record.

12. The method according to claim 5, wherein after replacing said long data records within said input data set with said sorted segment numbers of the respective data segments, the sequential position of the long data record within the original input data set and the segment number of its first data segment are saved with the reduced long data record.

13. The method according to claim 6, wherein after replacing said long data records within said input data set with said sorted segment numbers of the respective data segments, the sequential position of the long data record within the original input data set and the segment number of its first data segment are saved with the reduced long data record.

14. The method according to claim 7, wherein after replacing said long data records within said input data set with said sorted segment numbers of the respective data segments, the sequential position of the long data record within the original input data set and the segment number of its first data segment are saved with the reduced long data record.

15. The method according to claim 1, wherein said data segments of said long data records are padded to equal size by adding dummy bits to the respective data segments.

16. The method according to claim 2, wherein said data segments of said long data records are padded to equal size by adding dummy bits to the respective data segments.

17. The method according to claim 3, wherein said data segments of said long data records are padded to equal size by adding dummy bits to the respective data segments.

18. The method according to claim 4, wherein said data segments of said long data records are padded to equal size by adding dummy bits to the respective data segments.

19. The method according to claim 5, wherein said data segments of said long data records are padded to equal size by adding dummy bits to the respective data segments.

20. The method according to claim 6, wherein said data segments of said long data records are padded to equal size by adding dummy bits to the respective data segments.

21. The method according to claim 7, wherein said data segments of said long data records are padded to equal size by adding dummy bits to the respective data segments.

22. The method according to claim 8, wherein said data segments of said long data records are padded to equal size by adding dummy bits to the respective data segments.

23. The method according to claim 9, wherein said data segments of said long data records are padded to equal size by adding dummy bits to the respective data segments.

24. The method according to claim 10, wherein said data segments of said long data records are padded to-equal size by adding dummy bits to the respective data segments.

25. The method according to claim 11, wherein said data segments of said long data records are padded to equal size by adding dummy bits to the respective data segments.

26. The method according to claim 12, wherein said data segments of said long data records are padded to equal size by adding dummy bits to the respective data segments.

27. The method according to claim 13, wherein said data segments of said long data records are padded to equal size by adding dummy bits to the respective data segments.

28. The method according to claim 14, wherein said data segments of said long data records are padded to equal size by adding dummy bits to the respective data segments.

29. The method according to any one of claims 1 to 28, wherein said long data records are split into data segments sized at least 2048 bytes and at most 4092 bytes.

30. The method according to any one of claims 1 to 28, wherein said short data records are padded to equal size by adding dummy bits to said short data records.

31. The method according claim 29, wherein said short data records are padded to equal size by adding dummy bits to said short data records.

32. A device equipped for carrying out a method according to claim 1 comprising:
an extracting means for extracting long data records out of input data set,
a segmenting means for segmenting long data records into data segments of equal size,
a sorting means for sorting said data segments, for sorting said data segments by segment numbers, and for sorting said data records by said sorted segment numbers,
a storage means for storing outputs of said sorting means,
a replacing means for replacing said data segments by said sorted segments numbers, and vice versa, and
a reassembling means for reassembling said long data records from said sorted data segments.

33. A computer program implementing the method according to any one of claims 1 to 28 for a computer.

34. A computer program implementing the method according to claim 29 for a computer.

35. A computer program implementing the method according to claim 30 for a computer.

36. A computer program implementing the method according to claim 31 for a computer.

37. A computer program product comprising the computer program of claim 33.

38. A computer program product comprising the computer program of claim 34.

39. A computer program product comprising the computer program of claim 35.

40. A computer program product comprising the computer program of claim 36.

41. A computer program product comprising instructions for carrying out a method according to any one of claims 1 to 28.

42. A computer program product comprising instructions for carrying out a method according to claim 29.

43. A computer program product comprising instructions for carrying out a method according to claim 30.

44. A computer program product comprising instructions for carrying out a method according to claim 31.
